(19) United States
(12) Patent Application Publication
(10) Pub. No.: US 2026/0246789 A1
(43) Pub. Date: Aug. 20, 2026

(54) AUTOMATED INCIDENT INVESTIGATION USING GENERATIVE MACHINE LEARNING MODELS

(71) Applicant: Cisco Technology, Inc., San Jose, CA (US)

(72) Inventors: Yi Hong, Foster City, CA (US); Girish Pulprayil Chandranmenon, Edison, NJ (US); Tian Bu, Basking Ridge, NJ (US)

(21) Appl. No.: 19/173,404

(22) Filed: Apr. 8, 2025

Related U.S. Application Data
(60) Provisional application No. 63/761,138, filed on Feb. 20, 2025.

(51) Int. Cl. H04L 9/40

(52) U.S. Cl. CPC H04L 63/1416; H04L 63/1441

(57) ABSTRACT

This disclosure describes techniques for automatically investigating an incident associated with a monitored computing environment. In some cases, an example method includes providing first data associated with an incident; providing the first data to a first generative machine learning model; receiving, from the first generative machine learning model, second data representing a first query to a first data source system and a second query to a second data source system; receiving a first and a second query response from a first and a second data source system respectively; providing second data determined based on the first query response and the second query response to a second generative machine learning model; receiving, from the second generative machine learning model, third data representing at least one of: (i) a label associated with the incident, or (ii) a recommendation for responding to the incident; and performing an incident response action.

### CROSS-REFERENCES TO RELATED APPLICATIONS

The present application claims priority to U.S. Provisional Patent Application No. 63/761,138, entitled “Language Model Based Techniques for Automated Investigation of Security Incidents” and filed on Feb. 20, 2025, which is incorporated by referenced herein in its entirety and for all purposes.

### TECHNICAL FIELD

The present disclosure relates generally to incident management systems, and more specifically to automated incident investigation in those systems.

### BACKGROUND

Organizations use various security monitoring tools to detect potential security breaches within their computing environments. The sheer volume and complexity of data generated by these tools often present challenges in rapidly and accurately identifying the nature and scope of security incidents. Efficiently processing and interpreting this data to determine effective remediation strategies remains a critical need for increasing security of various computing environments.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 provides an example architecture for investigating an incident associated with a monitored computing environment.

FIG. 2 is a flowchart diagram of an example process for generating an investigation plan associated with an incident.

FIG. 3 is a flowchart diagram of an example process for determining query response description data based on an investigation plan.

FIG. 4 is a flowchart diagram of an example process for generating and performing an incident response action.

FIG. 5 is a flowchart diagram of an example process for training a planner agent.

FIG. 6 is a flowchart diagram of an example process for determining a prediction associated with an incident.

FIG. 7 is a flowchart diagram of an example process for training a generative machine learning model used for performing incident investigation.

FIG. 8 shows an example computer architecture for a computer capable of executing program components for implementing the functionality described above.

### DESCRIPTION OF EXAMPLE EMBODIMENTS

### Overview

This disclosure describes techniques for automatically investigating an incident associated with a monitored computing environment. In some cases, an example method includes providing first data associated with an incident, the incident being associated with a computing environment. The method may further include providing the first data and a first prompt to a first generative machine learning model. The method may further include receiving, from the first generative machine learning model, second data representing a first query to a first data source system and a second query to a second data source system. The method may further include providing the first query to the first data source system and the second query to the second data source system. The method may further include receiving, from the first data source system, a first query response. The method may further include receiving, from the second data source system, a second query response. The method may further include providing a second prompt and second data determined based on the first query response and the second query response to a second generative machine learning model. The method may further include receiving, from the second generative machine learning model, third data, the third data representing at least one of: (i) a label associated with the incident, or (ii) a recommendation for responding to the incident. The method may further include performing an incident response action based on the third data.

### Example Embodiments

This disclosure describes techniques for automatically investigating an incident associated with a monitored computing environment (e.g., one or more computing devices, systems, networks, and/or the like). The described techniques may, for example, be used by an incident management platform and/or an extended detection and/or response system (XDR) that is configured to: (i) determine prediction data associated with an incident (e.g., representing a label associated with the incident, a recommendation for responding to the incident, and/or the like), (ii) provide and/or display the prediction data, (iii) determine incident response action(s) based on the prediction data, and/or (iv) automatically execute operation(s) corresponding to the incident response action(s). The incident response action(s) may include initiating an automated remedial action, providing an alert to a user (e.g., to a security analyst using the incident response system and/or the XDR system), blocking access by a device that is determined be affected by an attack technique to a computer network and/or to a network device (e.g., a network device associated with a network service), monitoring network traffic associated with the affected device, blocking a network connection, disabling a user account, and/or quarantining an affected device.

In some cases, the techniques described herein automatically investigate an incident by using one or more generative machine learning models. A generative machine learning model may be a trained machine learning model that is configured to generate content data (e.g., text data, image data, audio data, video data, and/or the like). In some cases, a generative machine learning model is a transformer-based model, such as a transformer-based model that includes one or more attention-based mechanisms (e.g., one or more self-attention and/or cross-attention mechanisms). In some cases, a generative machine learning model includes a language model. In some cases, a generative machine learning model is configured to process a prompt and/or input content data to generate output content data. A prompt may, for example, represent an instruction to a generative machine learning model to perform a processing task based on the incident.

For example, in some cases, the techniques described herein automatically investigate an incident by using: (i) a first generative machine learning model (referred to herein as a “summarization agent”) that is configured to process incident data associated with an incident to generate an incident summary (e.g., a short description of the incident), (ii) a second generative machine learning model (referred to herein as a “planner agent”) that is configured to process data associated with an incident (e.g., the incident data received by the system, the incident summary generated by the summarization agent, and/or the like) to determine one or more investigative tasks associated with (e.g., one or more queries to) one or more data source systems (e.g., a dynamic playbook with a list of tasks to do for investigating the incident), (iii) a third set of generative machine learning models (referred to herein as “interpretation agents”), each of which may be configured to process a query response generated by querying a data source system to generate a query response description (e.g., one or more hints inferred based on an incident), and/or (iv) a fourth generative machine learning model (referred to herein as a “triage agent”) that is configured to process incident data associated with an incident and/or data determined based on query response(s) (e.g., based on query response description(s) generated by the interpretation agent(s)) to generate prediction data associated with the incident (e.g., a label associated with the incident, a recommendation for responding to the incident, and/or the like).

In some cases, an example system includes a set of incident processing agents that are configured to (e.g., collectively) process incident data associated with an incident to determine prediction data associated with that incident. The incident processing agents may include: (i) a summarization agent (e.g., as described above), (ii) a planner agent (e.g., as described above), (iii) a set of tooling agents, each of which is configured to generate a query for retrieving data from a data source system (e.g., based on an investigative task represented by the output of the planner agent, where the output of the planner agent may be natural language text and/or human-readable text description data), (iv) a set of execution agents, each of which is configured to execute a query (e.g., as generated by a tooling agent) against a data source system and/or to retrieve data from the data source system, (v) a set of interpretation agents (e.g., as described above), and/or (vi) a triage agent (e.g., as described above). In some cases, the system may also include an orchestration agent that is configured to coordinate execution (e.g., sequential and/or parallel execution) of the incident processing agent(s) based on incident data associated with a query.

In some cases, a system includes: (i) a summarization agent configured to generate a summary (e.g., a short description) of an incident (e.g., to provide to user(s) to describe what happened) based on incident data received by the system, (ii) a planner agent configured to generate task data (e.g., a dynamic playbook) with a set of investigative tasks based on the incident data and/or the incident summary, (iii) a set of tooling agents each configured to convert the task data generated by the planner agent (e.g., which may be in natural language text) into a set of computer-executable queries (e.g., database queries, commands, codecs, and/or the like), (iv) a set of execution agents each configured to execute a query determined by a tooling agent against a data source system to retrieve query response data (e.g., evidence data such as logs, IP reports, data about historical responses to similar incidents, and/or the like), (v) a set of interpretation agents each configured to process query response data retrieved by a query and/or by a set of queries performed by a specific execution agent to generate determine query response description data (e.g., hints inferred based on the query output data, which may be helpful in making decisions and/or generating predictions about an incident, such as in determining whether an incident is a true positive or a false positive), and (vi) a set of triage agents each configured to process the incident data and/or the query response description data (e.g., the inferred hint(s) determined based on the query response data) to determine a prediction (e.g., a prediction about whether an incident is true positive or false positive, recommended action(s) for responding to the incident, and/or the like).

For example, an orchestration agent may be configured to: (i) receive a request for investigating an incident, (ii) receive and/or determine incident data associated with that incident, (iii) provide the incident data to the summarization agent, (iv) receive, from the summarization agent, an incident summary, (iv) provide the incident summary to the planner agent, (v) receive, from the planner agent, a set of T investigative tasks (e.g., each representing data associated with a query to one of S data source systems), (vi) generate, using each of a set of S tooling agents, one or more queries to a respective one of the S data source systems, (vii) provide, to each of S execution agents associated with a respective one of the S data source systems, the one or more queries targeted at the respective one of the S data source systems, (viii) receive, from each of the S execution agents, one or more query responses, (ix) provide, to each of S interpretation agents associated with a respective one of the S data source systems, the query response(s) received from the respective data source system, (x) receive, from each of the S interpretation agents, one or more query response descriptions, (xi) provide the S sets of query response descriptions to a triage agent, and/or (xii) receive, from the triage agent, prediction data associated with the incident.

In some cases, the summarization agent is configured to process incident data and a prompt to generate an incident summary. The incident data may include log data, network traffic data, endpoint detection and response (EDR) data, and/or the like. In some cases, the prompt includes an instruction to generate a concise summary of the incident, and the summarization agent is configured to process the incident data and the prompt using a generative machine learning model (a pre-trained language model, which may be a transformer-based model) to generate an incident summary that highlights the essential aspects of the incident.

In some cases, the planner agent is configured to process the incident data and/or an incident summary (e.g., as generated by the summarization agent) and a prompt to generate an “investigation plan” representing a set of investigative tasks. In some cases, the prompt includes an instruction to generate data describing a structured set of queries that target specific data source systems (e.g., to obtain additional context related to the incident). In some cases, the planner agent is configured to process the incident summary and the prompt using a generative machine learning model (a pre-trained language model, which may be a transformer-based model) to generate the investigation plan that identifies a set of data source systems to be queried and the specific information to be queried from each data source system.

In some cases, the prompt provided to the planner agent may include an instruction to generate the investigation plan in a structured format, such as a Java Script Object Notation (JSON) format, that facilitates automated execution of the investigative tasks. In some cases, the structured format enables direct conversion of the investigation plan into executable queries for the data source systems. In some cases, the structured format is based on one or more query templates associated with one or more data source systems. In some cases, a query template defines a standardized structure for querying a particular data source system. The query template associated with a data source system may, for example, represent parameter(s) that may be provided and/or may be required for querying the data source system. In some cases, the planner agent is configured to process the incident summary and the prompt using a generative machine learning model to generate an investigation plan that identifies a set of investigative task description, where each investigative task description may (e.g., may be a data structure that identifies): (i) identify a particular data source system, and/or (ii) identify a set of parameters for querying the particular data source system. For example, an investigation plan may include: (i) a first investigative task description that represents querying a security information and event management (SIEM) system in accordance with a first query template to retrieve log data associated with a particular Internet Protocol (IP) address during a specified time period, (ii) a second investigative task description that represents querying an endpoint detection and response (EDR) system in accordance with a second query template to retrieve process execution data from a particular device, and/or (iii) a third investigative task description that represents querying a threat intelligence platform in accordance with a third query template to retrieve information about a particular indicator of compromise (IoC).

In some cases, a planner agent is trained (e.g., initially trained, fine-tuned, retrained, and/or the like) in accordance with: (i) one or more language modeling tasks (e.g., missing word prediction task(s), next word prediction task(s), and/or the like), (ii) one or more reinforcement learning with human agent (RLHF) tasks, and/or (iii) one or more supervised learning tasks. Training the planner agent based on a language modeling task(s) may be based on investigation plan(s) associated with past incidents. These past investigation plan(s) may be generated by human agent(s) and/or may be automatically generated based on: (i) tracking one or more queries performed by a user (e.g., a security analyst) in response to an incident, and/or (ii) generating a text description of the tracked quer(ies). The text description of a query may, for example, represent the data source system associated with the query and/or one or more parameters associated with the query. In some cases, training the planner agent based on a language modeling task includes predicting a subsequent word in a sequence of words representing an investigation plan. In some cases, a language modeling task includes predicting a missing word in a sequence of words representing an investigation plan.

In some cases, training the planner agent based on an RLHF task includes: (i) providing a first incident summary to the planner agent, (ii) receiving a first investigation plan from the planner agent, (iii) providing the first investigation plan to a human agent, (iv) receiving the human agent's feedback, (v) training, based on the human agent's feedback, a supervised machine learning model configured to predict human agent feedback based on investigation plan(s), (vi) providing a second incident summary to the planner agent, (vii) receiving a second investigation plan from the planner agent, (viii) providing the second investigation plan to the supervised model, (ix) receiving a predicted feedback from the supervised model, (x) determining a loss function based on the predicted feedback, and (xi) training the planner agent based on the loss function. Training a machine learning model based on a loss function may, for example, include setting parameter(s) of the model to optimize (e.g., locally and/or globally minimize) the loss function.

In some cases, training a planner agent based on a supervised task includes: (i) providing a first incident summary (e.g., a past incident summary) to the planner agent, (ii) receiving a first investigation plan (e.g., represented one or more predicted queries to one or more data source systems) from the planner agent, (iii) receiving a “target” investigation plan associated with the first incident summary (e.g., a ground-truth investigation plan associated with a past incident, such as a ground-truth investigation plan generated by human agent(s) and/or generated based on tracking one or more queries performed by a user in response to the past incident), (vi) determining a loss function based on a distance between the first investigation plan and the target investigation plan, and (x) training the planner agent based on the loss function. The distance between the two investigation plans may be determined based on a measure of distance between two text segments associated with the two investigation plans, such as based on a distance (e.g., a cosine distance, a Euclidean distance, and/or the like) and/or a similarity (e.g., a Jacard similarity) between embeddings (e.g., Paragraph2Vec embeddings, bag of word embeddings, and/or the like) associated with the two text segments. In some cases, the distance between the two investigation plans is determined based on a Jaccard similarity between their respective word sets and/or a Levenshtein distance between their respective text sequences.

In some cases, training a planner agent based on a supervised task includes: (i) providing a first incident summary (e.g., a past incident summary) associated with a first incident to the planner agent, (ii) receiving, from the planner agent, an embedding of the first incident summary as generated by the planner agent, (iii) providing the embedding to a classification model (e.g., a supervised machine learning model) that is configured to generate, based on the embedding, a set of labels representing a set of data source systems targeted by the investigative task(s) in the investigation plan, (iii) receiving, from the classification model, the set of labels, (iv) determining a loss function based on a difference of the set of labels and a set of “target” labels represented by a target investigation plan (e.g., as described above) associated with the first incident, and/or (v) training the planner agent based on the loss function. In some cases, the classification model may be a multi-label classification model that maps an incident summary embedding to a subset (e.g., one or more of) a set of candidate labels corresponding to a set of available data source systems. In some cases, the incident summary embedding may be a representation of the incident summary generated by a layer (e.g., by an encoder layer) of the planner agent.

In some cases, a tooling agent is configured to generate, based on an investigate task description, a query for execution against a corresponding data source system (e.g., by an execution agent associated with that corresponding data source system). Examples of data source systems include SIEM systems, EDR systems, network monitoring systems, threat intelligent systems, and/or the like. In some cases, a tooling agent is configured to generate, based on query parameter(s) represented by an investigative task description and/or a query template associated with a corresponding data source system, a query. In some cases, an execution agent is configured to execute a query generated by a tooling agent against the corresponding data source system to obtain a query response. In some cases, an execution agent is configured to provide the query response in a structured format, such as a JSON format.

In some cases, an interpretation agent is configured to process a query response (e.g., as received from an execution agent) and a prompt to generate a query response description. In some cases, the prompt includes an instruction to generate a textual description of the query response. In some cases, the interpretation agent is configured to process the query response and the prompt using a generative machine learning model (a pre-trained language model, which may be a transformer-based model) to generate the query response description. In some cases, the query response description represents a human-readable summary of the query response. In some cases, the interpretation agent is configured to process the query response and the prompt to generate the query response description in a structured format, such as a JSON format. In some cases, the structured format facilitates automated processing of the query response description. In some cases, the structured format includes one or more fields corresponding to data elements represented by the query response.

In some cases, an interpretation agent is trained in accordance with: (i) one or more language modeling tasks (e.g., missing word prediction task(s), next word prediction task(s), and/or the like), (ii) one or more RLHF tasks, and/or (iii) one or more supervised learning tasks. Training the interpretation agent based on a language modeling task(s) may be based on query response(s) (e.g., past query response(s)) received from a particular data source system and/or query response description(s) (e.g., query response description(s)) associated with query response(s) (e.g., past query response(s)). For example, in some cases, training the interpretation agent based on a language modeling task includes predicting a subsequent word in a sequence of words representing a query response and/or a query response description. As another example, in some cases, a language modeling task includes predicting a missing word in a sequence of words representing a query response and/or a query response description.

In some cases, training the interpretation agent based on an RLHF task includes: (i) providing a first query response to the interpretation agent, (ii) receiving a first query response description from the interpretation agent, (iii) providing the first query response description to a human agent, (iv) receive the human agent's feedback (e.g., user feedback), (v) training, based on the human agent's feedback, a supervised machine learning model configured to predict human agent feedback based on query response(s), (vi) providing a second query response to the interpretation agent, (vii) receiving a second query response description from the interpretation agent, (viii) providing the second query response to the supervised model, (ix) receiving a predicted feedback from the supervised model, (x) determining a loss function based on the predicted feedback, and (xi) training the interpretation agent based on the loss function. Training a machine learning model based on a loss function may, for example, include setting parameter(s) of the model to optimize (e.g., locally and/or globally minimize) the loss function.

In some cases, training an interpretation agent based on a supervised task includes: (i) providing a first query response (e.g., a past query response) to the interpretation agent, (ii) receiving a first query response description from the interpretation agent, (iii) receiving a “target” query response description associated with the first query response (e.g., a ground-truth query response description associated with a past query, such as a past query response description associated with a past query and/or a human-generated query response description associated with a past query), (vi) determining a loss function based on a distance between the first query response description and the target query response description, and (x) training the interpretation agent based on the loss function. The distance between the two query response descriptions may be determined based on a measure of distance between two text segments, such as based on a distance (e.g., a cosine distance, a Euclidean distance, and/or the like) and/or a similarity (e.g., a Jacard similarity) between embeddings (e.g., Paragraph2Vec embeddings, bag of word embeddings, and/or the like) associated with the two text segments. In some cases, the distance between the two query response descriptions is determined based on a Jaccard similarity between their respective word sets and/or a Levenshtein distance between their respective text sequences.

In some cases, a triage agent is configured to process the incident data and/or one or more query response descriptions (e.g., as received from one or more interpretation agents), and a prompt, to generate prediction data associated with the incident. In some cases, the prompt includes an instruction to generate a label associated with the incident. In some cases, the prompt includes an instruction to generate a recommendation for responding to the incident. In some cases, the triage agent is configured to process the query response descriptions and the prompt using a generative machine learning model (a pre-trained language model, which may be a transformer-based model) to generate the prediction data.

In some cases, a triage agent is trained in accordance with: (i) one or more language modeling tasks (e.g., missing word prediction task(s), next word prediction task(s), and/or the like), (ii) one or more RLHF tasks, and/or (iii) one or more supervised learning tasks. Training the triage agent based on a language modeling task(s) may be based on incident prediction(s) associated with past incidents. These past incident prediction(s) may be generated by human agent(s) and/or may be automatically generated based on query response(s) associated with past incident(s). In some cases, training the triage agent based on a language modeling task includes predicting a subsequent word in a sequence of words representing an incident prediction. In some cases, a language modeling task includes predicting a missing word in a sequence of words representing an incident prediction.

In some cases, training the triage agent is based on one or more RLHF tasks. In some cases, training the triage agent based on an RLHF task includes: (i) providing a first set of query response descriptions to the triage agent, (ii) receiving a first incident prediction from the triage agent, (iii) providing the first incident prediction set to a human agent, (iv) receiving the human agent's feedback, (v) training, based on the human agent's feedback, a supervised machine learning model configured to predict human agent feedback(s) based on incident prediction(s), (vi) providing a second set of query response descriptions to the triage agent, (vii) receiving a second incident prediction from the triage agent, (viii) providing the second incident prediction to the supervised model, (ix) receiving a predicted feedback from the supervised model, (x) determining a loss function based on the predicted feedback, and (xi) training the triage agent based on the loss function.

In some cases, training the triage agent based on a supervised task includes: (i) providing a set of query response descriptions associated with a first incident to the triage agent, (ii) receiving, from the triage agent, a first incident prediction, (iii) receiving a “target” incident prediction associated with the first incident, (iv) determining a loss function based on a distance between the first incident prediction and the target incident prediction, and (v) training the triage agent based on the loss function. In some cases, the distance between the two incident predictions is determined based on a measure of distance between text segments associated with the two incident predictions. In some cases, the measure of distance includes a cosine distance between embeddings associated with the two text segments associated with the two incident predictions. In some cases, the measure of distance includes a Jaccard similarity between word sets associated with the two text segments associated with the two incident predictions.

In some cases, an orchestration agent is configured to manage the execution of the incident processing agent(s). In some cases, the orchestration agent is configured to receive a request for investigating an incident. In some cases, the orchestration agent is configured to determine and/or receive incident data associated with the incident. In some cases, the orchestration agent is configured to provide the incident data to the summarization agent. In some cases, the orchestration agent is configured to receive an incident summary from the summarization agent. In some cases, the orchestration agent is configured to provide the incident summary to the planner agent. In some cases, the orchestration agent is configured to receive an investigation plan from the planner agent. In some cases, the orchestration agent is configured to receive one or more queries generated by one or more tooling agents and provide the one or more queries to one or more execution agents. In some cases, the orchestration agent is configured to receive one or more query responses from one or more execution agents. In some cases, the orchestration agent is configured to provide one or more query responses to one or more interpretation agents. In some cases, the orchestration agent is configured to receive one or more query response descriptions from one or more interpretation agents. In some cases, the orchestration agent is configured to provide one or more query response descriptions to the triage agent. In some cases, the orchestration agent is configured to receive prediction data from the triage agent.

In some cases, the techniques described herein improve computer security. In some cases, the techniques improve computer security by automating incident investigation. In some cases, automating incident investigation reduces the time required to respond to security incidents. In some cases, reducing the time required to respond to security incidents reduces the impact of security incidents. In some cases, the techniques improve computer security by providing more accurate incident analysis. In some cases, providing more accurate incident analysis enables more effective remediation of security incidents. In some cases, the techniques improve computer security by enabling proactive threat detection. In some cases, enabling proactive threat detection prevents security incidents from occurring.

In some cases, the techniques described herein improve computational efficiency. In some cases, the techniques improve computational efficiency by automating incident investigation. In some cases, automating incident investigation reduces the computational resources required for incident investigation. In some cases, reducing the computational resources required for incident investigation reduces the cost of incident investigation. In some cases, the techniques improve computational efficiency by using generative machine learning models. In some cases, using generative machine learning models enables more efficient processing of incident data. In some cases, enabling more efficient processing of incident data reduces the time required for incident investigation.

In some cases, the techniques described herein improve the scalability of incident investigation. In some cases, the techniques improve the scalability of incident investigation by automating incident investigation. In some cases, automating incident investigation enables the system to handle a larger volume of incidents. In some cases, the techniques improve the scalability of incident investigation by using generative machine learning models. In some cases, using generative machine learning models enables the system to process a larger volume of incident data.

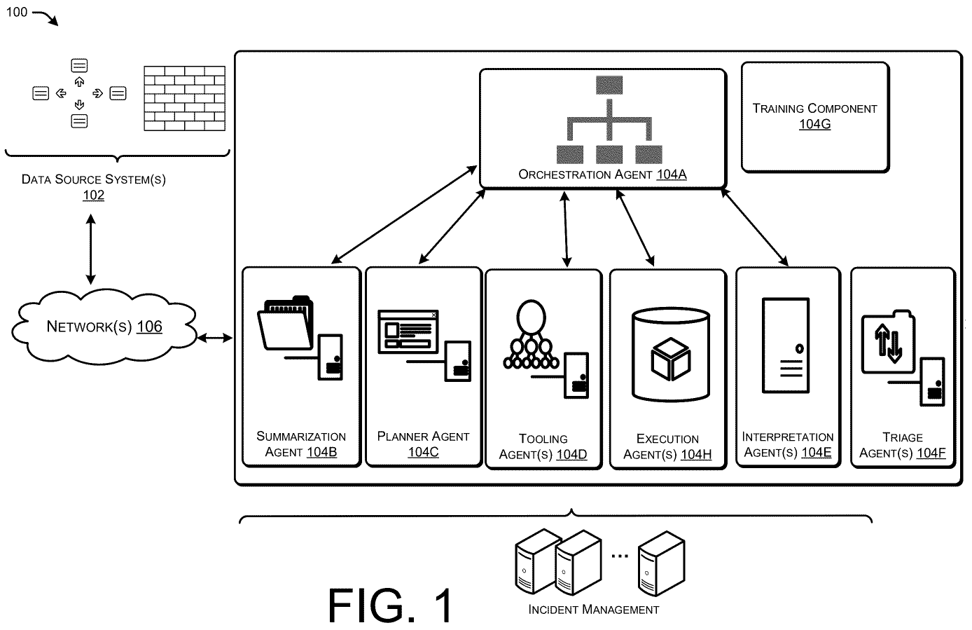

FIG. 1 provides an example architecture 100 for investigating an incident associated with a monitored computing environment. As depicted in FIG. 1, the architecture 100 includes one or more data source systems 102, one or more networks 106, and an incident management system 104. The incident management system 104 includes an orchestration agent 104A, a summarization agent 104B, a planner agent 104C, one or more tooling agents 104D, one or more execution agents 104H, one or more interpretation agents 104E, and a training component 104G.

In some cases, the data source systems 102 represent systems that store data related to a monitored computing environment. In some cases, examples of data source systems 102 include SIEM systems, EDR systems, network monitoring systems, and/or threat intelligence systems.

In some cases, the networks 106 represent communication networks that enable communication between the data source systems 102 and the incident management system 104. In some cases, the networks 106 include one or more local area networks (LANs) and/or wide area networks (WANs).

In some cases, the orchestration agent 104A is configured to coordinate the execution of the summarization agent 104B, the planner agent 104C, the tooling agents 104D, the execution agents 104H, and the interpretation agents 104E. In some cases, the orchestration agent 104A is configured to receive incident data and provide the incident data to the summarization agent 104B. In some cases, the orchestration agent 104A is configured to receive an incident summary from the summarization agent 104B and provide the incident summary to the planner agent 104C. In some cases, the orchestration agent 104A is configured to receive an investigation plan from the planner agent 104C and provide investigation plans to the tooling agents 104D. In some cases, the orchestration agent 104A is configured to receive one or more queries from the tooling agents 104D. In some cases, the orchestration agent 104A is configured to provide the one or more queries to the execution agents 104H, receive query responses from the execution agents 104H, and provide the query responses to the interpretation agents 104E. In some cases, the orchestration agent 104A is configured to receive query response descriptions from the interpretation agents 104E and provide the query response descriptions to the triage agent 104F. In some cases, the orchestration agent 104A is configured to receive prediction data from the triage agent 104F. In some cases, the orchestration agent 104A is configured to perform incident response action(s) represented by the prediction data received from the triage agent 104F.

In some cases, the summarization agent 104B is configured to process incident data and generate a summary of the incident. In some cases, the summarization agent 104B uses a generative machine learning model to generate the incident summary. In some cases, the incident data includes log data, network traffic data, and/or EDR data. Example operations for the summarization agent 104B are described above.

In some cases, the planner agent 104C is configured to process the incident summary and generate an investigation plan. In some cases, the investigation plan includes a set of investigative tasks, each representing a query to a data source system. In some cases, the planner agent 104C uses a generative machine learning model to generate the investigation plan. Example operations for the planner agent 104C are described above.

In some cases, the tooling agents 104D are configured to generate queries based on the investigation plan. In some cases, each tooling agent is associated with a specific data source system. In some cases, the tooling agents 104D receive query parameters from the orchestration agent 104A, and generate queries based on the received query parameters. Example operations for the tooling agents 104D are described above.

In some cases, the execution agents 104H are configured to execute queries against the data source systems 102. Example operations for the execution agents 104H are described above.

In some cases, the interpretation agents 104E are configured to process query responses and generate query response descriptions (e.g., as described above). In some cases, each interpretation agent is associated with a specific data source system. In some cases, each interpretation agent is configured to: (i) receive a query response generated by a tooling agent associated with the same data source system, and/or (ii) process the received query response to generate a query response description. In some cases, the interpretation agents 104E use generative machine learning models to generate the query response descriptions. Example operations for interpretation agents 104E are described above.

In some cases, the triage agent 104F is configured to process incident data and/or the query response descriptions and generate incident prediction data. In some cases, the incident prediction data includes a label associated with the incident and/or a recommendation for responding to the incident. The label associated with an incident may, for example, represent at least one of: (i) a determined cause associated with the incident, (ii) a component of the monitored computing environment that is determined to be affected by the incident, (iii) a type of attack technique associated with the incident, and/or (iv) a threat actor associated with the incident. In some cases, the recommendation for responding to the incident includes one or more remedial actions. In some cases, the remedial actions include initiating an automated remedial action, providing an alert to a user, blocking access by a device to a computer network, monitoring network traffic associated with a device, and/or quarantining a device. In some cases, the triage agent 104F uses a generative machine learning model to generate the incident prediction data. Example operations for the triage agent 104F are described above.

In some cases, the training component 104G is configured to train the summarization agent 104B, the planner agent 104C, the interpretation agents 104E, and/or the triage agent 104F. In some cases, training an agent includes using one or more supervised learning tasks, one or more RLHF tasks, and/or one or more language modeling tasks. Example techniques for training the summarization agent 104B, the planner agent 104C, the interpretation agents 104E, and the triage agent 104F are described above.

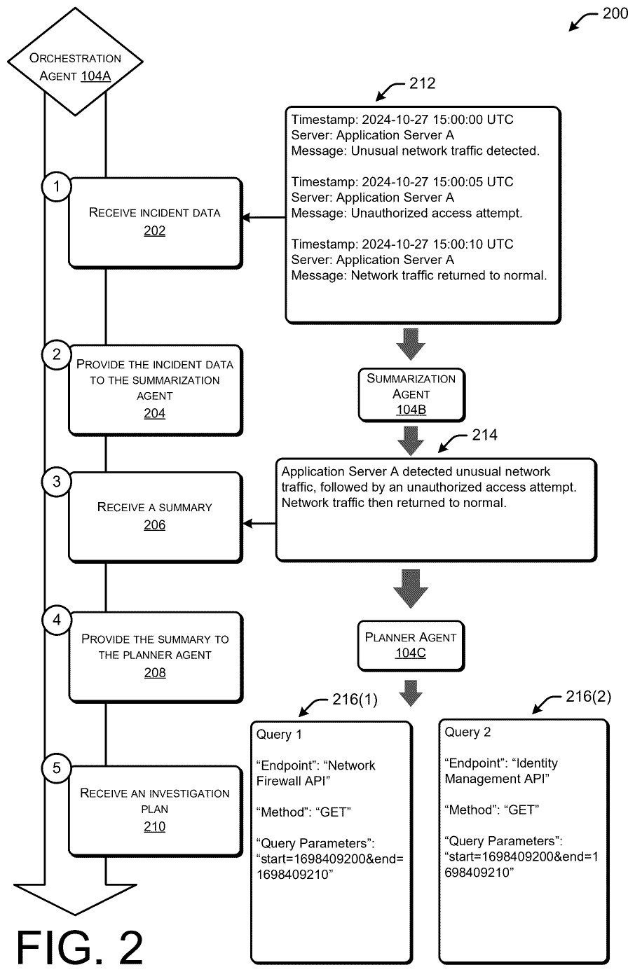

FIG. 2 is a flowchart diagram of an example process 200 for generating an investigation plan associated with an incident. As depicted in FIG. 2, at operation 202, the orchestration agent 104A receives incident data associated with an incident. For examples, as depicted in FIG. 2, the orchestration agent 104A may receive the incident data 212. Examples of incident data are described above.

At operation 204, the orchestration agent 104A provides the incident data to the summarization agent 104B. For example, as depicted in FIG. 2, the orchestration agent 104A provides the incident data 212 to the summarization agent 104B.

At operation 206, the orchestration agent 104A receives an incident data summary from the summarization agent 104B. For example, as depicted in FIG. 2, the orchestration agent 104A receives the incident data summary 214 from the summarization agent 104B. Example techniques for generating incident data summaries are described above.

At operation 208, the orchestration agent 104A provides the incident data summary to the planner agent 104C. For example, as depicted in FIG. 2, the orchestration agent 104A provides the incident data summary 214 to the planner agent 104C.

At operation 210, the orchestration agent 104A receives an investigation plan from the planner agent 104C. The investigation plan may include one or more investigative task descriptions. For example, as depicted in FIG. 2, the orchestration agent 104A receives an investigation plan including the investigative task description 216(1) and the investigative task description 216(B) from the planner agent 104C. Example techniques for generating investigation plans are described above.

An investigative task description may represent a target data source system, a method type, and/or one or more query parameters. For example, as depicted in FIG. 2, the investigative task description 216(1) represents a network firewall API, a GET method, and two query parameters. As another example, as depicted in FIG. 1, the investigative task description 216(2) represents an identify management API, a GET method, and two query parameters.

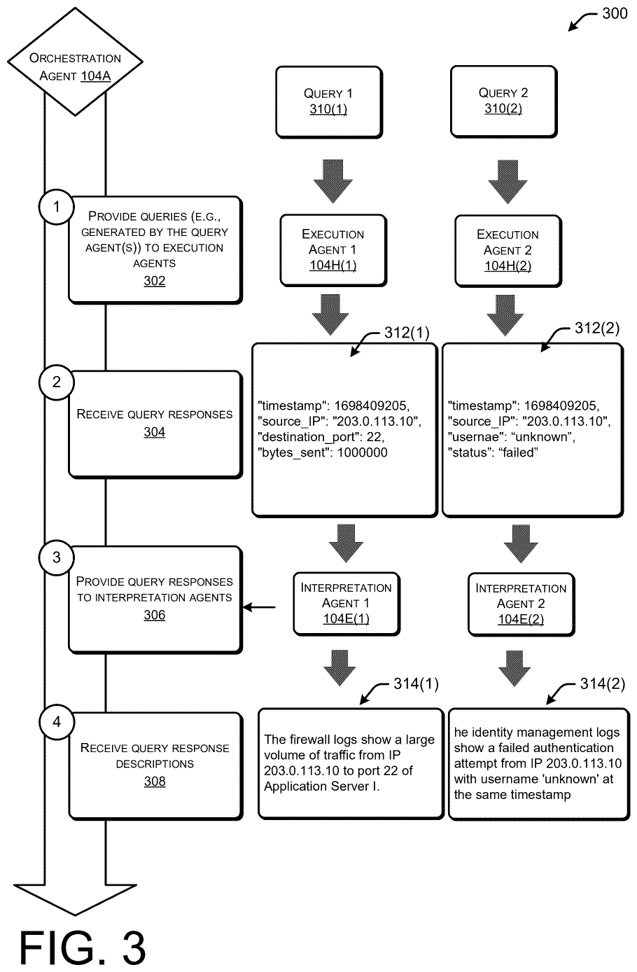

FIG. 3 is a flowchart diagram of an example process 300 for determining query response description data based on an investigation plan. As depicted in FIG. 3, at operation 302, orchestration agent 104A provides one or more queries determined based on an investigation plan to execution agents 104H. The queries may, for example, be determined based on one or more tooling agents 104D, based on the investigation plan. Example techniques for generating queries based on investigation plans are described above.

For example, as depicted in FIG. 3, the orchestration agent 104A provides a query 310(1) to an execution agent 104H(1) (e.g., which may be associated with a first target data source system) and a query 310(2) to an execution agent 104H(2) (e.g., which may be associated with a second target data source system).

At operation 304, the orchestration agent 104A receives query response(s) from the execution agents 104H. For example, as depicted in FIG. 3, the orchestration agent 104A receives a query response 312(1) from the execution agent 104H(1) and a query response 312(2) from the agent 104H(2). Example techniques for generating query responses are described above.

At operation 306, the orchestration agent 104A provides query response(s) to interpretation agents 104E. For example, as depicted in FIG. 3, the orchestration agent 104A provides the query response 312(1) to the interpretation agent 104E(1) (e.g., which may be associated with a first target data source system) and query response 312(2) to the interpretation agent 104E(2) (e.g., which may be associated with a second target data source system).

At operation 308, the orchestration agent 104A receives query response description(s) from the interpretation agents 104E. For example, as depicted in FIG. 3, the orchestration agent 104A receives the query response description 314(1) from the interpretation agent 104E(1) and the query response description 314(2) from the interpretation agent 104E(2). Example techniques for generating query response descriptions are described above.

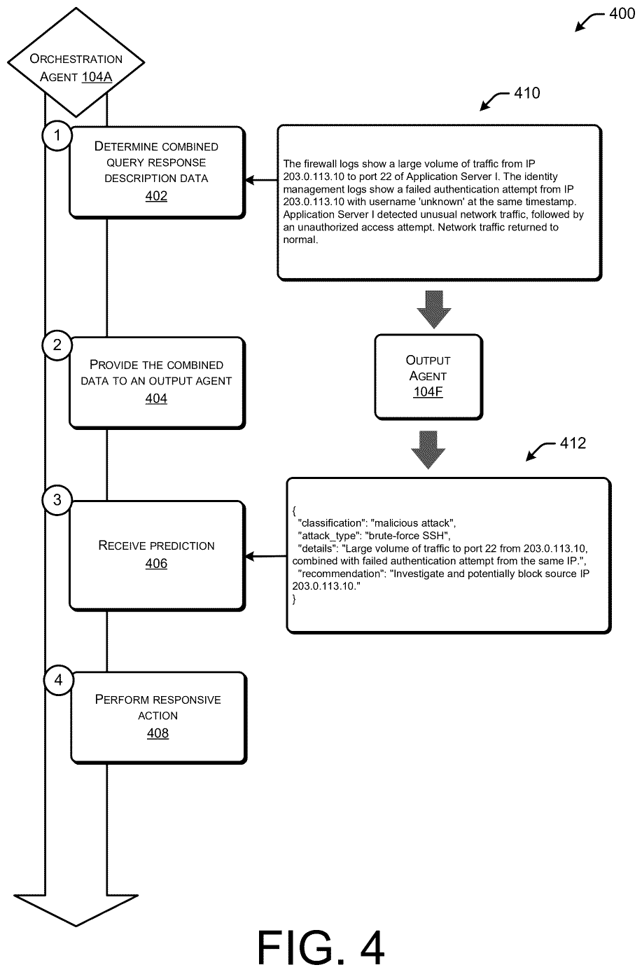

FIG. 4 is a flowchart diagram of an example process 400 for generating and performing an incident response action. As depicted in FIG. 4, at operation 402, the orchestration agent 104A determines combined query response description data based on the query response description(s) received from the interpretation agents 104E. In some cases, the orchestration agent 104A determines the combined query response description data based on combining (e.g., concatenating) the query response description(s) received from the interpretation agents 104E. For example, as depicted in FIG. 4, the orchestration agent 104A generates the combined query response description data 410 based on combining the query response description 314(1) and the query response description 314(2).

At operation 404, the orchestration agent 104A provides the combined query response description data to the triage agent 104F. For example, as depicted in FIG. 4, the orchestration agent 104A provides the combined query response description data 410 to the triage agent 104F.

At operation 406, the orchestration agent 104A receives a prediction from the triage agent 104F. For example, as depicted in FIG. 4, the orchestration agent 104A receives the prediction 412 from the triage agent 104F.

In some cases, the prediction represents one or more labels and/or a recommended incident response action. For example, as depicted in FIG. 4, the prediction 412 represents the following labels: a classification and an attack type. Additionally, the prediction 412 includes a textual description of the incident and a recommended incident response action, which relates to investigating and potentially blocking a particular IP address. Example techniques for generating incident-related predictions are described above.

At operation 408, the orchestration agent 104A performs an incident response action based on the prediction. For example, in FIG. 4, based on the prediction 412, the orchestration agent 104A may investigate and/or block the designated IP address.

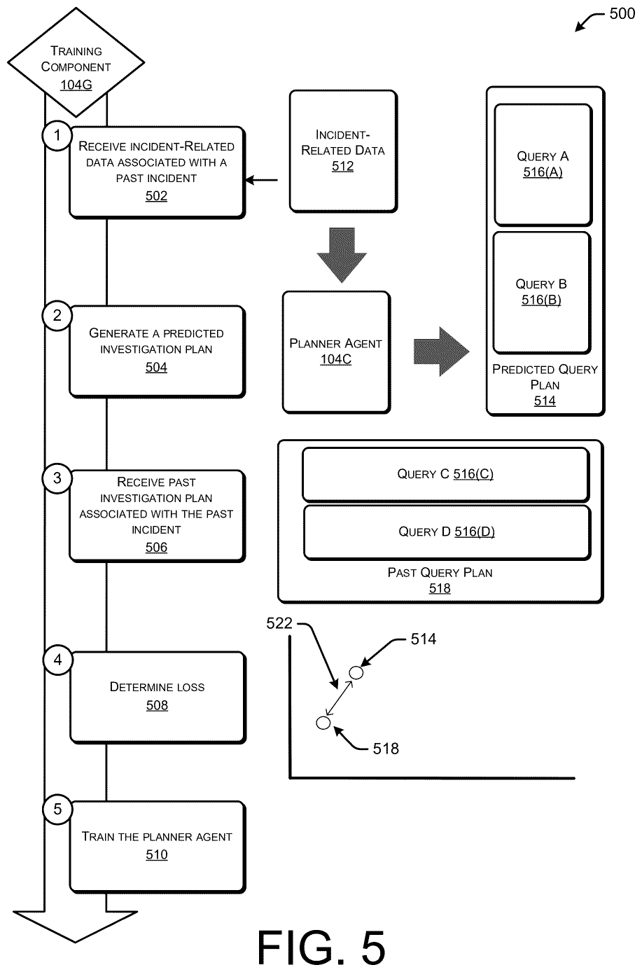

FIG. 5 is a flowchart diagram of an example process 500 for training a planner agent 104C. As depicted in FIG. 5, at operation 502, the training component 104G receives incident-related data associated with a past incident. The incident-related data may, for example, represent incident data associated with the incident, an incident summary generated based on the incident data (e.g., based on processing the incident data using the summarization agent 104B), and/or the like. For example, as depicted in FIG. 5, the training component 104G receives the incident-related data 512.

At operation 504, the training component 104G generates a predicted investigation plan based on the incident-related data. In some cases, generating a predicted investigation plan based on incident-related data includes processing the incident-related data using the planner agent 104C. For example, as depicted in FIG. 5, the training component 104G causes the planner agent 104C to process the incident-related data 512 to generate the predicted query plan 514, which represents a query A 516(A) and a query B 516(B). Example techniques for generating predicted investigation plans (e.g., predicted query plans) are described above.

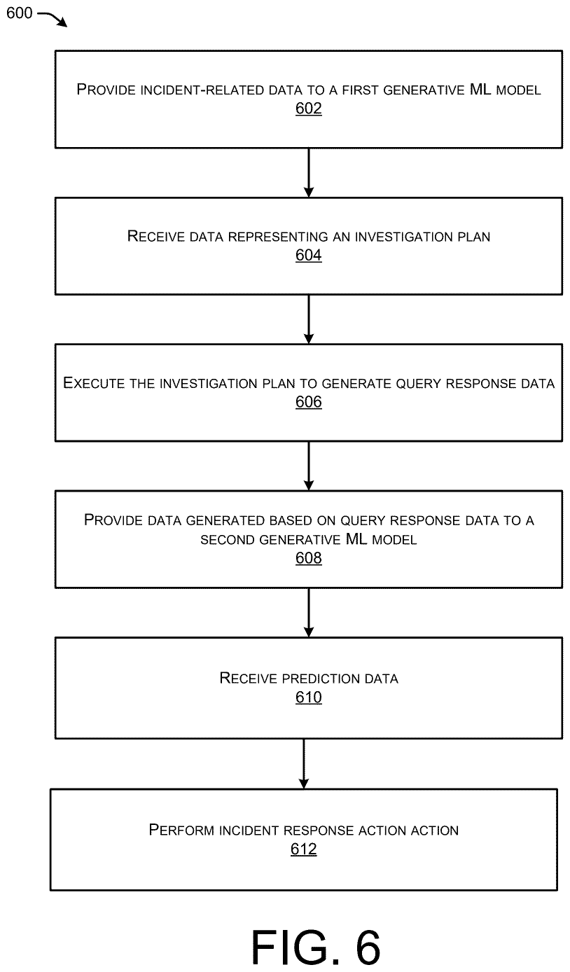

At operation 506, the training component 104G receives a past investigation plan (e.g., a ground-truth investigation plan) associated with the past incident. For example, as depicted in FIG. 6, the training component 104G receives the past query plan 518, that includes a query C 516(C) and a query D 516(D). In some cases, the past investigation plan includes a ground-truth investigation plan associated with the past incident, such as a ground-truth investigation plan generated by human agent(s) and/or generated based on tracking one or more queries performed by a user in response to the past incident. Example techniques for generating ground-truth investigation plans based on tracked user queries are described above.

For example, in some cases, to generate the ground-truth investigation plan, a system may track one or more queries performed by a security analyst in response to the past incident. In some cases, the system may generate a text description of the tracked queries. In some cases, the text description represents a data source system associated with each query. In some cases, the text description represents one or more parameters associated with each query.

At operation 508, the training component 104G determines a loss function based on a difference between the investigation plan generated by the planner agent 104C and the past investigation plan. For example, as depicted in FIG. 5, the training component 104G determines a loss based on a difference 522 (e.g., a distance) between an embedding associated with the predicted query plan 514 and an embedding associated with the past query plan 518.

In some cases, the difference between the two investigation plans is determined based on a measure of distance between two text segments associated with the two investigation plans. In some cases, the measure of distance is determined based on a cosine distance between embeddings associated with the two text segments. In some cases, the measure of distance is determined based on a Jaccard similarity between word sets associated with the two text segments. In some cases, the measure of distance is determined based on a Levenshtein distance between the two text sequences.

At operation 510, the training component 104G trains the planner agent 104C based on the loss function. In some cases, training the planner agent 104C based on the loss function includes setting one or more parameters of the planner agent 104C. In some cases, setting the parameters of the planner agent 104C includes optimizing the loss function. In some cases, optimizing the loss function includes locally minimizing the loss function. In some cases, optimizing the loss function includes globally minimizing the loss function.

FIG. 6 is a flowchart diagram of an example process 600 for determining a prediction associated with an incident. As depicted in FIG. 6, at operation 602, an example system provides incident-related data associated with an incident to a first generative machine learning model (e.g., the planner agent 104C). Examples of incident-related data are described above.

At operation 604, the system receives, from the first generative machine learning model, an investigation plan representing a set of investigative tasks. Each investigative task may represent a query to a source data system. Examples of investigative tasks are described above.

At operation 606, the system executes the investigation plan to generate query response data. In some cases, executing the investigation plan includes providing each investigative task to a corresponding tooling agent 104D. In some cases, executing the investigation plan includes receiving, from each tooling agent 104D, a query response. In some cases, the query response data includes one or more query responses.

At operation 608, the system provides data determined based on the query response data (e.g., based on interpreting the query response data, for example using the interpretation agents 104E) to a second generative machine learning model (e.g., the triage agent 104F). In some cases, providing the query response data to the second generative machine learning model includes providing query response descriptions generated by interpretation agents 104E to the triage agent 104F. In some cases, the query response descriptions are generated by processing the query responses using generative machine learning models.

At operation 610, the system receives, from the second generative machine learning model, a prediction associated with the incident. In some cases, the prediction includes a label associated with the incident and/or a recommendation for responding to the incident. Examples of incident prediction data are described above.

At operation 612, the system uses the prediction to execute one or more remedial actions. In some cases, the one or more remedial actions include providing an alert to a user. In some cases, the one or more remedial actions include blocking access by a device to a computer network. In some cases, the one or more remedial actions include monitoring network traffic associated with a device. In some cases, the one or more remedial actions include quarantining a device.

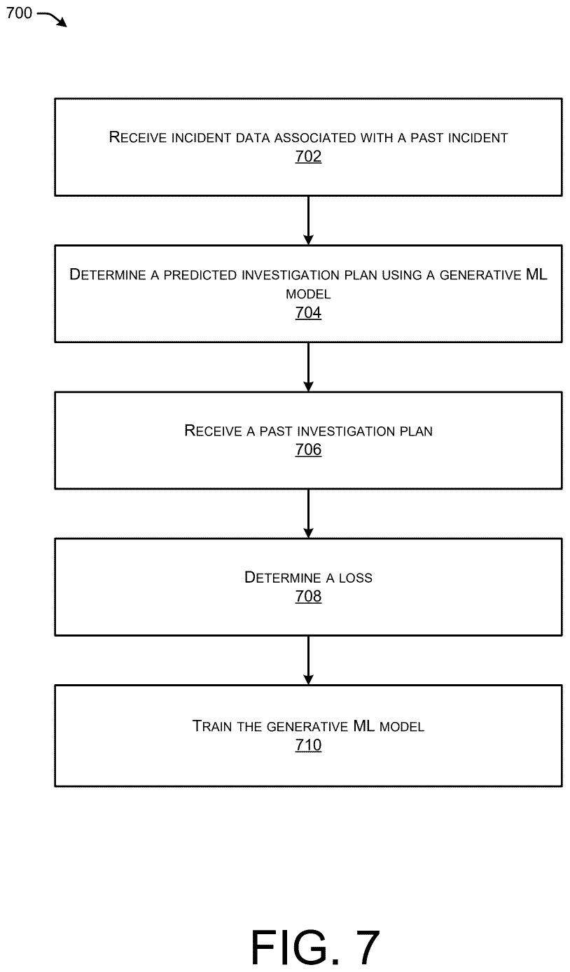

FIG. 7 is a flowchart diagram of an example process 700 for training a generative machine learning model (e.g., the planner agent 104C) used for performing incident investigation. As depicted in FIG. 7, at operation 702, an example system receives incident-related data (e.g., incident summary data) associated with a past incident. Examples of incident-related data are described above.

At operation 704, the system determines a predicted investigation plan using the generative machine learning model. In some cases, the predicted investigation plan represents a set of investigative tasks. In some cases, each investigative task represents a query to a source data system. Example techniques for generating predicted investigation plans are described above.

At operation 706, the system receives a past investigation plan associated with the past incident. In some cases, the past investigation plan includes a ground-truth investigation plan. In some cases, the ground-truth investigation plan is generated by human agents. In some cases, the ground-truth investigation plan is generated based on tracking queries performed by a user in response to the past incident.

At operation 708, the system determines a loss function. In some cases, the loss function is based on a difference between the predicted investigation plan and the past investigation plan. In some cases, the difference is determined based on a measure of distance between text segments. Example techniques for determining a loss between two investigation plans are described above.

At operation 710, the system trains the generative machine learning model. In some cases, training the generative machine learning model includes setting parameters of the model. In some cases, setting parameters includes optimizing the loss function. In some cases, optimizing the loss function includes locally minimizing the loss function. In some cases, optimizing the loss function includes globally minimizing the loss function.

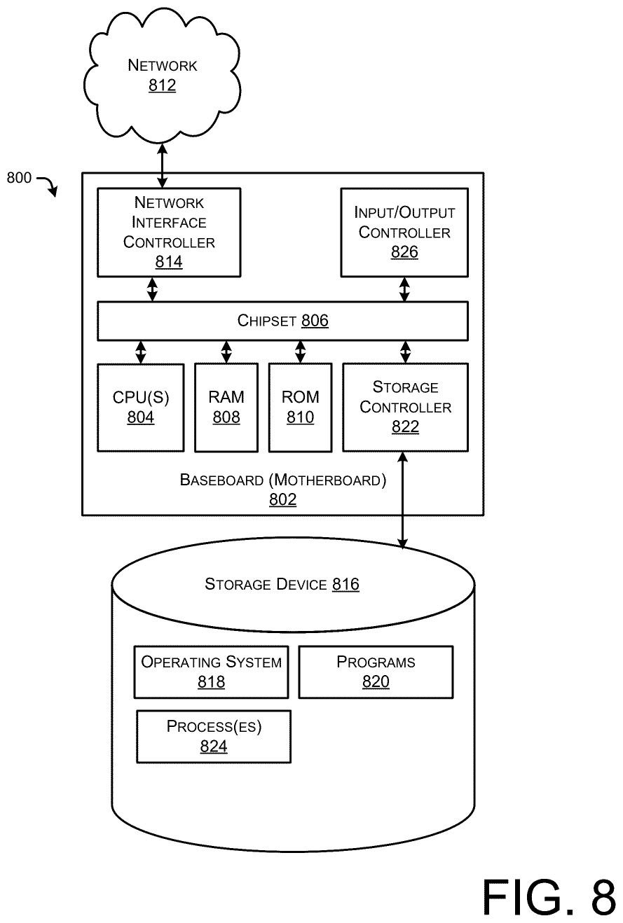

FIG. 8 shows an example computer architecture for a computer 800 capable of executing program components for implementing the functionality described above. The computer architecture shown in FIG. 8 illustrates a conventional server computer, workstation, desktop computer, laptop, tablet, network appliance, e-reader, smartphone, or other computing device, and can be utilized to execute any of the software components presented herein. The computer 800 may, in some examples, correspond to a network node (e.g., the 8) described herein.

The computer 800 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computer 800.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a random-access memory (RAM) 808, used as the main memory in the computer 800. The chipset 806 can further provide an interface to a computer-readable storage medium such as a read-only memory (ROM) 810 or non-volatile RAM (NVRAM) for storing basic routines that help to startup the computer 800 and to transfer information between the various components and devices. The ROM 810 or NVRAM can also store other software components necessary for the operation of the computer 800 in accordance with the configurations described herein.

The computer 800 can operate in a networked environment using logical connections to remote computing devices and computer systems through a network, such as the network 812. The chipset 806 can include functionality for providing network connectivity through a network interface controller (NIC) 814, such as a gigabit Ethernet adapter. The NIC 814 is capable of connecting the computer 800 to other computing devices over the network 812. It should be appreciated that multiple NICs 814 can be present in the computer 800, connecting the computer 800 to other types of networks and remote computer systems. In some instances, the NICs 814 may include at least on ingress port and/or at least one egress port.

The computer 800 can be connected to a storage device 816 that provides non-volatile storage for the computer. The storage device 816 can store an operating system 818, programs 820, and data, which have been described in greater detail herein. The storage device 816 can be connected to the computer 800 through a storage controller 822 connected to the chipset 806. The storage device 816 can consist of one or more physical storage units. The storage device 816 can interface with the physical storage units through a serial attached small computer system interface (SCSI) (SAS) interface, a serial advanced technology attachment (SATA) interface, a fiber channel (FC) interface, or other type of interface for physically connecting and transferring data between computers and physical storage units.

The computer 800 can store data on the storage device 816 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 816 is characterized as primary or secondary storage, and the like.

For example, the computer 800 can store information to the storage device 816 by issuing instructions through the storage controller 822 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 800 can further read information from the storage device 816 by detecting the physical states or characteristics of one or more particular locations within the physical storage units.

In addition to the storage device 816 described above, the computer 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 800. In some examples, the operations performed by any network node described herein may be supported by one or more devices similar to computer 800. Stated otherwise, some or all of the operations performed by a network node may be performed by one or more computers 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 816 can store an operating system 818 utilized to control the operation of the computer 800. According to one embodiment, the operating system comprises the LINUX™ operating system. According to another embodiment, the operating system includes the WINDOWS™ SERVER operating system from MICROSOFT Corporation of Redmond, Washington. According to further embodiments, the operating system can comprise the UNIX™ operating system or one of its variants. It should be appreciated that other operating systems can also be utilized. The storage device 816 can store other system or application programs and data utilized by the computer 800.

In one embodiment, the storage device 816 or other computer-readable storage media is encoded with computer-executable instructions which, when loaded into the computer 800, transform the computer from a general-purpose computing system into a special-purpose computer capable of implementing the embodiments described herein. These computer-executable instructions transform the computer 800 by specifying how the CPUs 804 transition between states, as described above. According to one embodiment, the computer 800 has access to computer-readable storage media storing computer-executable instructions which, when executed by the computer 800, perform the various processes described above with regard to FIGS. 1-7. The computer 800 can also include computer-readable storage media having instructions stored thereupon for performing any of the other computer-implemented operations described herein.

As illustrated in FIG. 8, the storage device 816 stores the programs 820, which may include one or more processes 824, as well as YY. The processes 824 may include instructions that, when executed by the CPUs 804, cause the computer 800 and/or the CPUs 804 to perform one or more operations.

The computer 800 can also include at least one input/output controller 826 for receiving and processing input from a number of input devices, such as a keyboard, a mouse, a touchpad, a touch screen, an electronic stylus, or other type of input device. Similarly, an input/output controller 826 can provide output to a display, such as a computer monitor, a flat-panel display, a digital projector, a printer, or other type of output device. It will be appreciated that the computer 800 might not include all of the components shown in FIG. 8, can include other components that are not explicitly shown in FIG. 8, or might utilize an architecture completely different than that shown in FIG. 8.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
providing first data associated with an incident, the incident being associated with a computing environment;
providing the first data and a first prompt to a first generative machine learning model;
receiving, from the first generative machine learning model, second data representing a first query to a first data source system and a second query to a second data source system;
providing the first query to the first data source system and the second query to the second data source system;
receiving, from the first data source system, a first query response;
receiving, from the second data source system, a second query response;
providing a second prompt and second data determined based on the first query response and the second query response to a second generative machine learning model;
receiving, from the second generative machine learning model, third data, the third data representing at least one of: (i) a label associated with the incident, or (ii) a recommendation for responding to the incident; and
performing an incident response action based on the third data.

2. The method of claim 1, wherein the first data comprises structured data associated with the incident.

3. The method of claim 1, wherein determining the first data comprises:
providing structured data and a third prompt associated with the incident to a third generative machine learning model; and
receiving, from the third generative machine learning model, the first data.

4. The method of claim 1, wherein training the first generative machine learning model comprises:
determining, based on a past incident and using the first generative machine learning model, a predicted query;
determining a loss based on the predicted query and a past query, the past query being associated with the past incident; and
training the first generative machine learning model based on the loss.

5. The method of claim 4, wherein determining the predicted query comprises:
providing fourth data associated with the past incident to the first generative machine learning model;
receiving, from the first generative machine learning model, fifth data;
providing the fifth data to a third generative machine learning model; and
receiving, from the third generative machine learning model, the predicted query.

6. The method of claim 1, wherein the first data source system comprises at least one of a security information and event management (SIEM) system, an endpoint detection and response (EDR) system, or a threat intelligence platform.

7. The method of claim 1, further comprising:
receiving user feedback associated with the incident response action; and
fine-tuning at least one of the first generative machine learning model or the second generative machine learning model based on the user feedback.

8. The method of claim 1, wherein the incident response action comprises at least one of blocking a network connection, quarantining a device, or disabling a user account.

9. A system comprising:
one or more processors; and
one or more non-transitory computer-readable media storing computer-executable instructions that, when executed, cause the system to perform operations comprising:
providing first data associated with an incident, the incident being associated with a computing environment;
providing the first data and a first prompt to a first generative machine learning model;
receiving, from the first generative machine learning model, second data representing a first query to a first data source system and a second query to a second data source system;
providing the first query to the first data source system and the second query to the second data source system;
receiving, from the first data source system, a first query response;
receiving, from the second data source system, a second query response;
providing a second prompt and second data determined based on the first query response and the second query response to a second generative machine learning model;
receiving, from the second generative machine learning model, third data, the third data representing at least one of: (i) a label associated with the incident, or (ii) a recommendation for responding to the incident; and
performing an incident response action based on the third data.

10. The system of claim 9, wherein the first data comprises structured data associated with the incident.

11. The system of claim 9, wherein determining the first data comprises:
providing structured data and a third prompt associated with the incident to a third generative machine learning model; and
receiving, from the third generative machine learning model, the first data.

12. The system of claim 9, wherein training the first generative machine learning model comprises:
determining, based on a past incident and using the first generative machine learning model, a predicted query;
determining a loss based on the predicted query and a past query, the past query being associated with the past incident; and
training the first generative machine learning model based on the loss.

13. The system of claim 12, wherein determining the predicted query comprises:
providing fourth data associated with the past incident to the first generative machine learning model;
receiving, from the first generative machine learning model, fifth data;
providing the fifth data to a third generative machine learning model; and
receiving, from the third generative machine learning model, the predicted query.

14. The system of claim 9, wherein the first data source system comprises at least one of a security information and event management (SIEM) system, an endpoint detection and response (EDR) system, or a threat intelligence platform.

15. The system of claim 9, the operations further comprising:
receiving user feedback associated with the incident response action; and
fine-tuning at least one of the first generative machine learning model or the second generative machine learning model based on the user feedback.

16. The system of claim 9, wherein the incident response action comprises at least one of blocking a network connection, quarantining a device, or disabling a user account.

17. One or more non-transitory computer-readable media storing instructions executable by one or more processors, wherein the instructions, when executed, cause the one or more processors to perform operations comprising:
providing first data associated with an incident, the incident being associated with a computing environment;
providing the first data and a first prompt to a first generative machine learning model;
receiving, from the first generative machine learning model, second data representing a first query to a first data source system and a second query to a second data source system;
providing the first query to the first data source system and the second query to the second data source system;
receiving, from the first data source system, a first query response;
receiving, from the second data source system, a second query response;
providing a second prompt and second data determined based on the first query response and the second query response to a second generative machine learning model;
receiving, from the second generative machine learning model, third data, the third data representing at least one of: (i) a label associated with the incident, or (ii) a recommendation for responding to the incident; and
performing an incident response action based on the third data.

18. The one or more non-transitory computer-readable media of claim 17, wherein the first data comprises structured data associated with the incident.

19. The one or more non-transitory computer-readable media of claim 17, wherein determining the first data comprises:
providing structured data and a third prompt associated with the incident to a third generative machine learning model; and
receiving, from the third generative machine learning model, the first data.

20. The one or more non-transitory computer-readable media of claim 17, wherein training the first generative machine learning model comprises:
determining, based on a past incident and using the first generative machine learning model, a predicted query;
determining a loss based on the predicted query and a past query, the past query being associated with the past incident; and
training the first generative machine learning model based on the loss.
